(19) United States
(12) Patent Application Publication
(10) Pub. No.: US 2003/0019694 A1
(43) Pub. Date: Jan. 30, 2003

(54) Dry interface corner vehicle braking system

(75) Inventor: Bryan P. Riddiford, Dayton, OH (US)

Correspondence Address: SCOTT A. MCBAIN, DELPHI TECHNOLOGIES, INC., Legal Staff, Mail Code: 480-414-420, P.O. Box 5052, Troy, MI, 48007-5052, US

(73) Assignee: Delphi Technologies, Inc.

(21) Appl. No.: 09/918,013

(22) Filed: Jul. 30, 2001

(51) Int. Cl. F16D 66/00

(52) U.S. Cl. 188/1.11 E; 188/1.11 R

(57) ABSTRACT

A braking assembly (102) and method for use with a brake by wire system provides braking forces to first and second wheels (104, 106) as a function of first and second electrical brake signals. A first hydraulic brake assembly (108) coupled to the first wheel (104) applies a first braking force to the first wheel (104). A second hydraulic brake assembly (110) coupled to the second wheel (106) applies a second braking force to the second wheel (106). A first pressure sensor (112) senses a pressure of the first hydraulic brake assembly (108) and responsively produces a first pressure signal. A second pressure sensor (114) senses a pressure of the second hydraulic brake assembly (110) and responsively produces a second pressure signal. A controller (116) receives a desired brake actuation signal and responsively determines the first and second electrical brake signals. The controller also receives the first and second pressure signals, responsively detects a non-linear condition of the braking assembly (102) and responsively modifies at least one of the first and second electrical brake signals in response to detecting the non-linear condition.

### FIELD OF THE INVENTION

The above referenced invention relates to an improvement in brake actuator design and specifically improves initial brake system response time.

### BACKGROUND OF THE INVENTION

Hydraulic braking systems have typically been the basis for vehicle braking systems, especially automotive braking systems. Hydraulic systems are used to convert fluid pressure into linear and/or mechanical motion. Such systems allow the source of the hydraulic pressure to be positioned remotely from the cylinders which affect the braking action. These systems comprise an actuator, such as a brake pedal, reservoir fluid which is responsive to pressure applied by the actuator, (such as a master cylinder) and means for converting the hydraulic pressure to a braking force, generally fluid cylinders. Mechanical braking pressure is achieved by utilizing the force of the depression of the brake pedal by the driver to increase the pressure on the master cylinder. Such systems are typically accompanied by a vacuum boost which multiplies the force supplied to the brake pedal, throughout the braking operation. The increased pressure in the master cylinder is then transmitted through fluid lines to the fluid cylinders. The fluid cylinders operate the calipers thereby forcing the calipers and brake pads against the rotors and/or drums which slows the vehicle by frictional force.

Hydraulic systems of the above described type have many disadvantages. These include the large amount of volume and mass that the master cylinder vacuum booster, ABS modulator and hydraulic line add to the completed vehicle. Installation of standard hydraulic braking systems is also complicated and labor intensive. Additionally, the large number of parts and installation also adds to repair and maintenance issues as individual parts reach the end of their useful life. Standard hydraulic braking systems have also become dependent on the vacuum boost to assist in braking operations. However, vehicles such as electric or hybrid vehicles do not produce vacuum as a by-product of the vehicle operation. Thus vacuum boost is not an option on such vehicles.

In order to overcome some of the hydraulic system disadvantages, electric brake systems are known. While there are many variant forms, including electrical hydraulic systems, the use of electric in the variant forms is also referred to as a brake by wire brake system (BBW). BBW describes the ability to activate vehicle wheel brakes via an electric signal generated by an onboard processor/controller as a result of input signals thereto. Brake torque is applied to the wheels without direct mechanical interaction between the vehicle's brake pedal and the wheel brake.

A particular type of BBW systems is known as a “dry interface corner' system (DIC). The typical DIC system operates when a driver inputs a force to the brake pedal. A force sensor and/or travel sensor attached to the pedal transmits an electronic signal to an electronic controller, which in turn sends the signal to the self contained braking device typically located at each wheel of the vehicle. The DIC system is known as a hybrid system in that electric signals are used to generate the type and amount of braking force required at each wheel of the vehicle with electrical wires rather than standard hydraulic brake lines. Located at each corner of the vehicle is a self-contained module which takes the electrical signal and mechanically brakes the vehicle. The self contained module utilizes an individual motor that drives a ball screw piston assembly which pressurizes hydraulic brake fluid to ultimately apply the brake caliper to a rotor at that corner of the vehicle. Such a DIC system significantly reduces assembly cost. The individual modules can be separately assembled and fluid filled prior to the manufacture of the vehicle. DIC modules then only need to be bolted to the automobile during the assembly process and plugged in using standard electrical connections. Finally, the elimination of hydraulic lines stretching throughout the vehicle as well as the elimination of the master cylinder booster, and ABS modulator reduces space requirements within the engine compartment.

Due to the modularity of the DIC system, each of the individual components is preferably kept relatively small while still meeting a baseline brake response. Such a system keeps the DIC module a manageable size and does not overextend the existing electrical system on a vehicle. Such a system works well in most brake system applications.

During typical usage, these systems are operated within a linear range of the system using a linear control mode. However, in certain instances the vehicle operator desires to decrease the initial brake system response time and shorten the vehicle stopping distance. However, the amount of fluid displacement to achieve pressure is limited by the size and speed of the motor and the gear ratio of the ball screw assembly. Operation of the system under these conditions may result in operation of the system in a nonlinear range. Thus, the system's performance may be degraded.

While increasing the size of the motor or the piston assembly and/or a combination thereof can decrease the initial brake system response time and result in a shorter vehicle stopping distance, such systems are unnecessary or impractical for most braking applications. Furthermore, such a combination would also result in greater size requirements for the DIC module and could have larger electrical load requirements from the vehicle power system.

The present invention is aimed at one or more of the problems identified above.

### SUMMARY OF THE INVENTION AND ADVANTAGES

In one aspect of the present invention, a braking assembly for providing braking forces to first and second wheels as a function of first and second electrical brake signals, is provided. The braking assembly includes a first wheel brake coupled to the first wheel for applying a first braking force to the first wheel and a first actuator coupled to the first wheel brake for controllably supplying fluid to the first wheel brake for actuation thereof in response to receiving the electrical brake signal. The braking assembly also includes a second wheel brake coupled to the second wheel for applying a second braking force to the second wheel and a second actuator coupled to the second wheel brake for controllably supplying fluid to the second wheel brake for actuation thereof in response to receiving the electrical brake signal. A first pressure sensor senses a pressure of the first wheel brake and responsively producing a first pressure signal. A second pressure sensor senses a pressure of the second wheel brake and responsively producing a second pressure signal. A controller receives a desired brake actuation signal and responsively determines the first and second electrical brake signals. The controller also receives the first and second pressure signals, compares the first and second pressure signals and detects a pressure differential condition, wherein at least one of the first and second electrical brake signals are modified to allow the pressure differential condition to dissipate if the pressure differential condition is detected.

In another aspect of the present invention, a braking assembly, for use in a brake by wire system, for providing braking forces to first and second wheels as a function of first and second electrical brake signals, is provided. A first hydraulic brake assembly is coupled to the first wheel for applying a first braking force to the first wheel. A second hydraulic brake assembly is coupled to the second wheel for applying a second braking force to the second wheel. A first pressure sensor for senses a pressure of the first hydraulic brake assembly and responsively produces a first pressure signal. A second pressure sensor senses a pressure of the second hydraulic brake assembly and responsively produces a second pressure signal. A controller receives a desired brake actuation signal and responsively determines the first and second electrical brake signals. The controller also receives the first and second pressure signals, responsively detects a non-linear condition of the braking assembly and responsively modifies at least one of the first and second electrical brake signals in response to detecting the non-linear condition.

In still another aspect of the present invention, a method for providing braking forces to first and second wheels as a function of first and second electrical brake signals using a braking assembly, is provided. The braking assembly includes a first wheel brake coupled to the first wheel for applying a braking force to the first wheel and a first actuator coupled to the first wheel brake for controllably supplying fluid to the first wheel brake for actuation thereof in response to receiving the electrical brake signal. The braking assembly also includes a second wheel brake coupled to the second wheel for applying a braking force to the second wheel and a second actuator coupled to the second wheel brake for controllably supplying fluid to the second wheel brake for actuation thereof in response to receiving the electrical brake signal. The method including the steps of receiving a desired brake actuation signal at the controller and responsively determining the first and second electrical brake signals, detecting a first pressure of the first wheel brake and responsively producing a first pressure signal, and detecting a second pressure of the second wheel brake and responsively producing a second pressure signal. The method also includes the steps of comparing the first and second pressure signals and detecting a pressure differential condition and modifying at least one of the first and second electrical brake signals to allow the pressure differential condition to dissipate if the pressure differential condition is detected.

In yet another aspect of the present invention, a method for providing braking forces to first and second wheels as a function of first and second electrical brake signals in a brake by wire system using a braking assembly, is provided. The braking assembly includes first and second hydraulic brake assemblies for applying braking forces to the first and second wheels. The method including the steps of receiving a desired brake actuation signal and responsively determining the first and second electrical brake signals, detecting a non-linear condition of the braking assembly, and, modifying at least one of the first and second electrical brake signals in response to detecting the non-linear condition.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 is a diagrammatic illustration of a braking system of the present invention;

FIG. 2 is a diagrammatic illustration of a hydraulic braking assembly of the braking system of FIG. 1, according to an embodiment of the present invention;

FIG. 3 is a flowchart of a method for operating a brake assembly, according to an embodiment of the present invention; and,

FIG. 4 is a flowchart of a method for operating a brake assembly, according to another embodiment of the present invention.

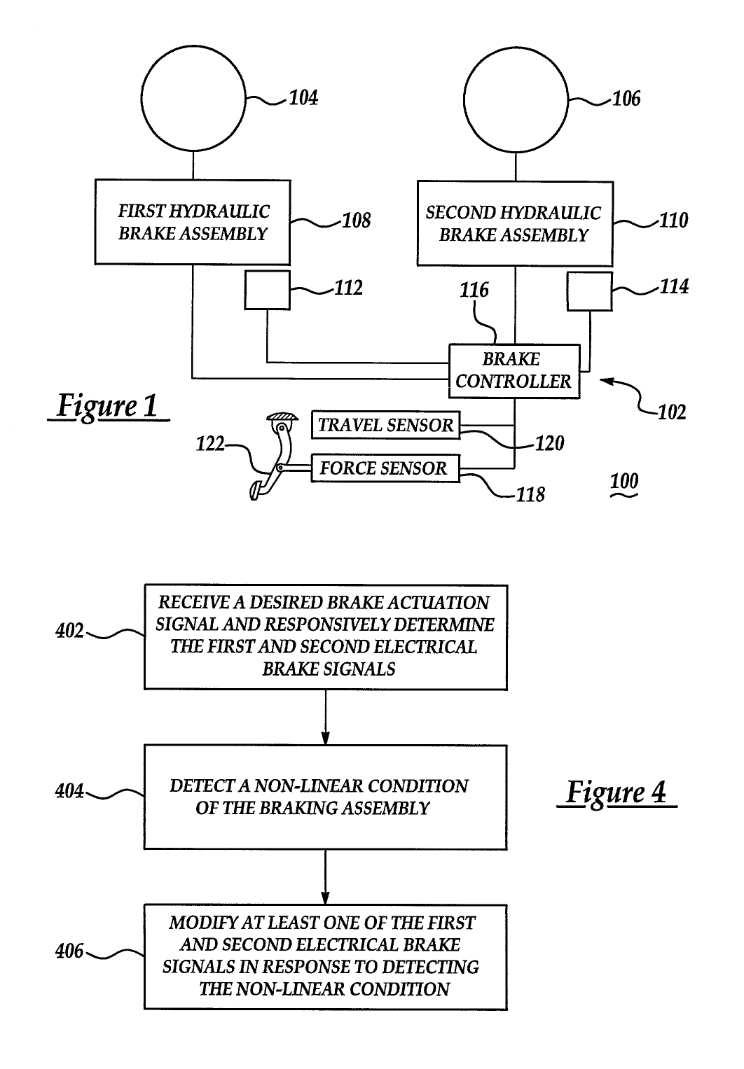

### DETAILED DESCRIPTION OF THE PREFERRED EMBODIMENT

Referring to the drawings, where the showings are for the purpose of illustrating the preferred embodiment of the invention only, and not for the purpose of limiting same, a braking assembly 102, for use in a brake by wire system 100 in a vehicle (not shown), for providing braking forces to first and second wheels 104, 106 as a function of first and second electrical brake signals, is provided. The detailed embodiment shows the present invention used in front wheel brake applications. It will be appreciated that others, upon experimentation with specific applications, may provide the invention at the rear brakes, both front and rear brakes, or some combination thereof.

The brake assembly 102 includes a first hydraulic brake assembly 108 coupled to the first wheel 104 for applying a first braking force to the first wheel 104 and a second hydraulic brake assembly 110 coupled to the second wheel 106 for applying a second braking force to the second wheel 106. A first pressure sensor 112 senses a pressure of the first hydraulic brake assembly and responsively produces a first pressure signal. A second pressure sensor 114 senses a pressure of the second hydraulic brake assembly and responsively produces a second pressure signal.

A controller 116 receives a desired brake actuation signal and responsively determines the first and second electrical brake signals. The controller 116 also receives the first and second pressure signals, responsively detects a non-linear condition of the braking assembly and responsively modifies at least one of the first and second electrical brake signals in response to detecting the nonlinear condition.

In one embodiment, the desired brake actuation signal is generated by a force sensor 118 and/or travel sensor 120 coupled to a user operated brake pedal 122.

During normal braking operations, the operator or user presses brake pedal 122 which is sensed by the force sensor 118 and sends a signal or desired brake actuation signal to controller 116 or brake control module 116. The controller 116 in turn generates an electrical brake or command signal to actuate the first and second hydraulic brake assemblies 108, 110 to generate respective brake forces which are applied to the first and second wheels, respectively. During normal braking operators, the first and second hydraulic brake assemblies operate in a linear operating range.

However, under certain conditions a vehicle operator may desire to stop the vehicle in a shorter stopping distance by applying force to brake pedal 122 at a faster rate. Under these conditions, the command signals may be saturated, i.e., at a maximum value. In attempting to follow the command signals, one or both of the hydraulic brake assemblies may be operated in a non-linear range of operation. This may result in a non-desirable unequal application of braking force being applied to the first and second wheels 104, 106. In response to detecting such a condition, one or both of the electrical brake signals or commands are modified until the condition no longer exists.

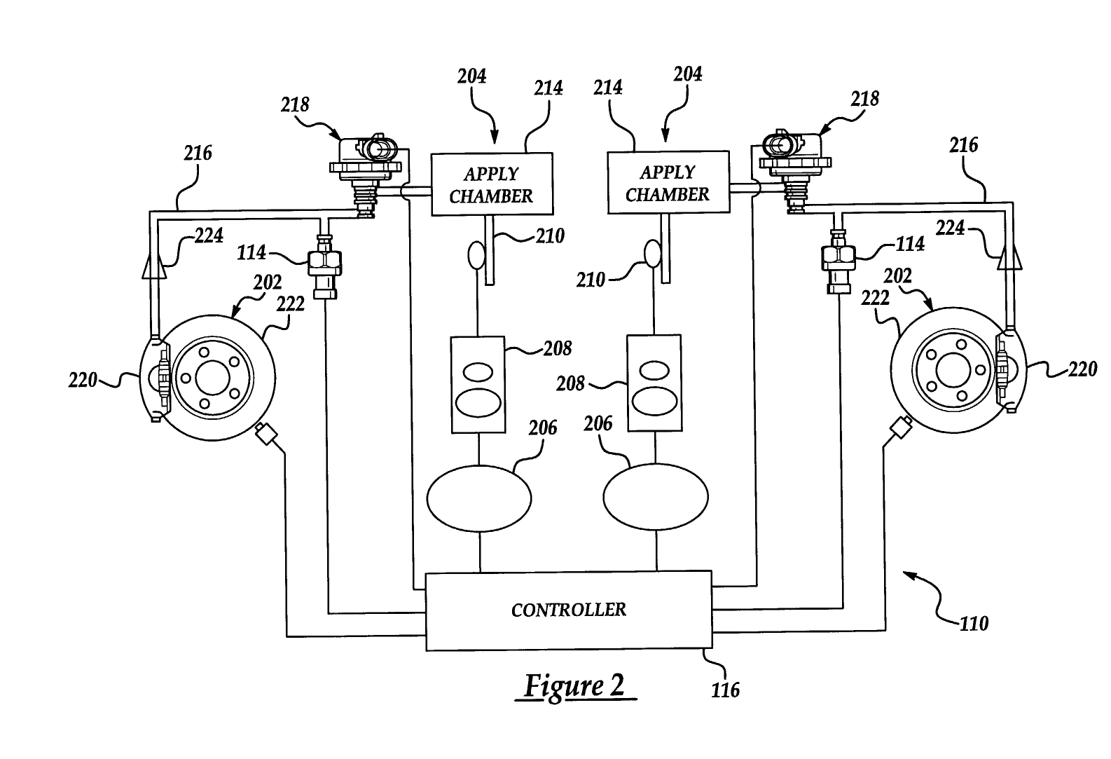

With specific reference to FIG. 2, a more detailed illustration of the first and second hydraulic brake assemblies, according to an embodiment of the present invention is illustrated. Specifically, the first and second hydraulic brake assemblies are shown as left front (LF) and right front (RF) brakes assemblies. The LF assembly will now be discussed in detail. The RF assembly is identical and is numerically identified with identical numerals.

The first or LF hydraulic brake assembly 108 includes a wheel brake 202 coupled to the first wheel 104 for applying a first braking force to the first wheel 104. An actuator 204 is coupled to the first wheel brake 202 for controllably supplying fluid to the first wheel brake 202 for actuation thereof in response to receiving the electrical brake signal from the controller 116.

The controller 116 is electrically connected to a motor 206 of the actuator 204. The motor 206 drives a gear mechanism 208 and ball screw assembly 210 that applies and releases a hydraulic piston 212 within an apply chamber 214. Extending from the valve 210 is a primary fluid line 216. Located within the primary fluid line 216 is a normally open solenoid valve 218.

The first wheel brake 202 includes brake calipers 220 and a rotor 222. During a normal brake apply and release, displaced brake fluid flows within the primary fluid line 216, through the normally open solenoid 218 and through an outlet 224. The fluid pressure therein applies and releases the brake calipers 220 against the rotor 222.

During normal braking operations, the solenoid valve 218 is in a normally open state. Accordingly, the operator presses the brake pedal 122, thereby generating a desired brake actuation signal and delivering the desired brake actuation signal to the controller 116. The brake controller 116 in turn generates a signal to actuate the motor 206 to pressurize the primary fluid line 216.

However, as discussed above, under certain conditions, the operator may desire to stop the vehicle in a shorter stopping distance by applying force to the brake pedal 122 at a faster rate. In response, the controller 116 sends a maximum command to the motor 206 which may create a non-linear response in either the first and/or second hydraulic brake assemblies 108, 110 and thus, an undesirable unequal application of the brakes.

In one embodiment, the controller 116 compares the first and second pressure signals and detects a pressure differential condition as an indication of operation in a non-linear range of the response of the brake system 100. If the pressure differential condition is detected, the controller 116 modifies at least one of the first and second electrical brake signals are modified to allow the pressure differential condition to dissipate.

In one embodiment, the electrical brake signals are modified discretely. Commands to the motor are reduced to a low command level when the pressure differential condition is detected. The low command level is a value that is calibrated to reduce the apply rate to approximately the slowest acceptable apply rate minus an offset, but not slow enough to stop the apply. The low command level will generally be a positive value. Otherwise the apply rate may slow down too much and the opposite side will be too fast. Preferably, value may be either a high value or a low value. Both the low and the high values are below the previous motor command. The actual value of the low command level is dependent upon the respective first or second pressure. If the respective pressure is above a predetermined threshold, then the high value is used. Otherwise, the low value is used.

In another embodiment, the electrical brake signals are modified continuously to control the fast apply rate to the slow apply rate. A closed loop control law, such as PID, may be used.

In one embodiment, the pressure differential condition is detected if a difference between the first and second pressure signals is greater than a predetermined threshold.

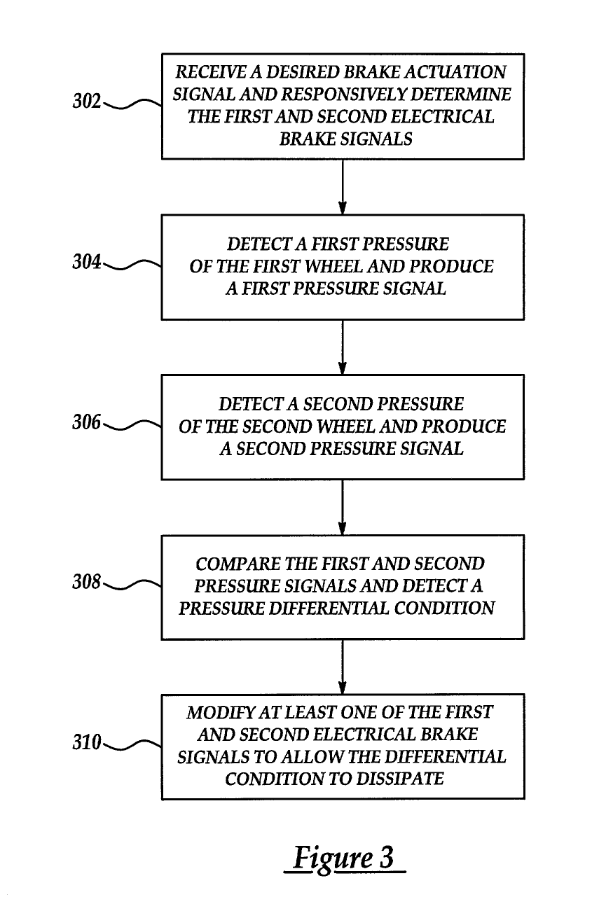

With reference to FIG. 3, operation of the braking assembly 102 according to an embodiment of the present invention will now be discussed. In a first process block 302, a desired brake actuation signal is received at the controller 116 and first and second electrical brake signals are determined. In a second process block 304, a first pressure of the first wheel brake is detected and a first pressure signal is produced. In a third process block 306, a second pressure of the second wheel brake is detected and a second pressure sensor is responsively produced. In a fourth process block 308, the first and second pressure signals are compares and a pressure differential condition is detected. In a fifth process block 310 at least one of the first and second electrical brake signals is modified to allow the pressure differential condition to dissipate if the pressure differential condition is detected.

In one embodiment, the pressure differential condition is detected if a difference between the first and second pressure signals is greater than a predetermined threshold.

With reference to FIG. 4, operation of the braking assembly 102 according to another embodiment of the present invention will now be discussed. In a first process block 402, a desired brake actuation signal is received and first and second electrical brake signals are determined.

In a second process block 404, a non-linear condition of the braking assembly is detected. In a third process block 406, at least one of the first and second electrical brake signals are modified in response to detecting the non-linear condition.

The invention has been described with reference to the preferred embodiment. Obviously, modifications and alterations will occur to others upon reading and understanding this specification. It is intended to include all such modifications and alterations in so far as they come within the scope of the appended claims.

What is claimed is:

1. A braking assembly (102) for providing braking forces to first and second wheels (104, 106) as a function of first and second electrical brake signals, comprising:
a first wheel brake (202) coupled to the first wheel (104) for applying a first braking force to the first wheel (104);
a first actuator (204) coupled to the first wheel brake (202) for controllably supplying fluid to the first wheel brake (202) for actuation thereof in response to receiving the electrical brake signal;
a second wheel brake (202) coupled to the second wheel (106) for applying a second braking force to the second wheel (106);
a second actuator (204) coupled to the second wheel brake (106) for controllably supplying fluid to the second wheel brake (106) for actuation thereof in response to receiving the electrical brake signal;
a first pressure sensor (112) for sensing a pressure of the first wheel brake (202) and responsively producing a first pressure signal;
a second pressure sensor (114) for sensing a pressure of the second wheel brake (202) and responsively producing a second pressure signal;
a controller (116) for receiving a desired brake actuation signal and responsively determining the first and second electrical brake signals and for receiving the first and second pressure signals, comparing the first and second pressure signals and detecting a pressure differential condition, wherein at least one of the first and second electrical brake signals are modified to allow the pressure differential condition to dissipate if the pressure differential condition is detected.

2. A braking assembly (102), as set forth in claim 1, wherein the pressure differential condition is detected if a difference between the first and second pressure signals is greater than a predetermined threshold.

3. A braking assembly (102), as set forth in claim 1, wherein the first and second actuator (204) include an actuator body (214), a motor (206), a piston (212) within the actuator body (214) and being coupled to the motor (206), the motor (206) being adapted to apply and release the piston (212).

4. A brake assembly (102), as set forth in claim 1, wherein the actuators (204) include a motor (206).

5. A brake assembly (102), as set forth in claim 4, wherein the actuators (204) further include a motor-gear-ball screw assembly (210) coupled to the motor (206), an apply chamber (214) coupled between the motor-gear-ball screw assembly (210) and the wheel brake (202).

6. A brake assembly (102), as set forth in claim 1, wherein the wheel brakes (202) include a brake caliper coupled to the actuator (204).

7. A brake assembly (102), as set forth in claim 8, wherein the wheel brakes (202) further include a rotor (222).

8. A braking assembly (102) for providing braking forces to first and second wheels (104, 106) as a function of first and second electrical brake signals, comprising:
a first rotor (222) coupled to the first wheel (104) for applying a first braking force to the first wheel;
a first brake caliper (220) for actuating the first rotor (222) in response to a first fluid flow;
a first actuator piston (212) within a first actuator body (214);
a first motor (206) coupled to the first piston (212), the first motor (206) being adapted to apply and release the first piston (212), the first piston (212) being adapted to controllably supply fluid to the first brake caliper (220) for actuation thereof in response to receiving the first electrical brake signal;
a second rotor (222) coupled to the second wheel (106) for applying a second braking force to the second wheel (106);
a second brake caliper (220) for actuating the second rotor (222) in response to a second fluid flow;
a second actuator piston (212) within a second actuator body (214);
a second motor (206) coupled to the second piston (212), the second motor (206) being adapted to apply and release the second piston (212), the second piston (212) being adapted to controllably supply fluid to the second brake caliper (220) for actuation thereof in response to receiving the second electrical brake signal;
a controller (116) for receiving a desired brake actuation signal and responsively determining the first and second electrical brake signals and for receiving the first and second pressure signals, comparing the first and second pressure signals and detecting a pressure differential condition, wherein at least one of the first and second electrical brake signals are modified to allow the pressure differential condition to dissipate if the pressure differential condition is detected.

9. A braking assembly (102), as set forth in claim 8, wherein the pressure differential condition is detected if a difference between the first and second pressure signals is greater than a predetermined threshold.

10. A brake assembly (102), as set forth in claim 8, wherein including a first motor-gear-ball screw assembly (210) coupled to the first motor (206) and a first apply chamber (214) coupled between the first motor-gear-ball screw assembly (210) and the first brake caliper (220) and a second motor-gear-ball screw assembly coupled to the second motor (206) and a second apply chamber (214) coupled between the second motor-gear-ball screw assembly (210) and the second brake caliper (220).

11. A method for providing braking forces to first and second wheels (104, 106) as a function of first and second electrical brake signals using a braking assembly (102), the braking assembly (102) having a first wheel brake (202) coupled to the first wheel (104) for applying a braking force to the first wheel (104) and a first actuator (202) coupled to the first wheel brake (202) for controllably supplying fluid to the first wheel brake (202) for actuation thereof in response to receiving the electrical brake signal, the braking assembly (102) also having a second wheel brake (202) coupled to the second wheel (106) for applying a braking force to the second wheel (106) and a second actuator (204) coupled to the second wheel brake (202) for controllably supplying fluid to the second wheel brake (202) for actuation thereof in response to receiving the electrical brake signal, the method including the steps of:
receiving a desired brake actuation signal at a controller and responsively determining the first and second electrical brake signals;
detecting a first pressure of the first wheel brake (202) and responsively producing a first pressure signal;
detecting a second pressure of the second wheel brake (202) and responsively producing a second pressure signal;
comparing the first and second pressure signals and detecting a pressure differential condition; and, modifying at least one of the first and second electrical brake signals to allow the pressure differential condition to dissipate if the pressure differential condition is detected.

12. A method, as set forth in claim 11, wherein the pressure differential condition is detected if a difference between the first and second pressure signals is greater than a predetermined threshold.

13. A method for providing braking forces to first and second wheels (104, 106) as a function of first and second electrical brake signals in a brake by wire system using a braking assembly (102), the braking assembly (102) having first and second hydraulic brake assemblies (108, 110) for applying braking forces to the first and second wheels (104, 106), the method including the steps of:
receiving a desired brake actuation signal and responsively determining the first and second electrical brake signals;
detecting a non-linear condition of the braking assembly (102); and,
modifying at least one of the first and second electrical brake signals in response to detecting the non-linear condition.

14. A braking assembly (102), for use in a brake by wire system, for providing braking forces to first and second wheels (104, 106) as a function of first and second electrical brake signals, comprising:
a first hydraulic brake assembly (108) coupled to the first wheel (104) for applying a first braking force to the first wheel (104);
a second hydraulic brake assembly (110) coupled to the second wheel (106) for applying a second braking force to the second wheel (106);
a first pressure sensor (112) for sensing a pressure of the first hydraulic brake assembly (108) and responsively producing a first pressure signal;
a second pressure sensor (114) for sensing a pressure of the second hydraulic brake assembly (110) and responsively producing a second pressure signal;
a controller (116) for receiving a desired brake actuation signal and responsively determining the first and second electrical brake signals and for receiving the first and second pressure signals, responsively detecting a non-linear condition of the braking assembly (102) and responsively modifying at least one of the first and second electrical brake signals in response to detecting the non-linear condition.
